(19) United States
(12) Patent Application Publication
(10) Pub. No.: US 2016/0374165 A1
(43) Pub. Date: Dec. 22, 2016

(54) BACKLIGHT MODULE AND LIQUID-CRYSTAL DISPLAY DEVICE USING THE SAME

(71) Applicant: InnoLux Corporation, Miao-Li County (TW)

(72) Inventors: Yung-Yu TSAI, Miao-Li County (TW); Ying-Wen YANG, Miao-Li County (TW); Ching-Wen SHIH, Miao-Li County (TW); Tai-Chieh HUANG, Miao-Li County (TW); Ching-Yu CHENG, Miao-Li County (TW); Tzu-Hao WANG, Miao-Li County (TW)

(21) Appl. No.: 15/184,101

(22) Filed: Jun. 16, 2016

(30) Foreign Application Priority Data
Jun. 18, 2015 (CN) 201510340113.0
Jan. 4, 2016 (CN) 201610003249.7

(51) Int. Cl. H05B 33/08; G02F 1/1335; H05B 37/02

(52) U.S. Cl. CPC H05B 33/0821; H05B 37/0272; H05B 37/0254; G02F 1/133603

(57) ABSTRACT

A backlight module is provided, and includes: a plurality of LED strings, each of which is formed from a plurality of LEDs connected in series and has an LED string current flowing through it, and a dimming controller which controls the duty cycle of a voltage pulse wave supplied to each of the LED strings, wherein the LED string current of each of the LED strings multiplied by the duty cycle of the voltage pulse wave for the same LED string equals a value, and the error between the values of the LED strings is within 6% of any of the values.

### CROSS REFERENCE TO RELATED APPLICATIONS

This Application claims priority of China Patent Application No. 201510340113.0, filed on Jun. 18, 2015, and priority of China Patent Application No. 201610003249.7, filed on Jan. 4, 2016, the entireties of which are incorporated by reference herein.

### BACKGROUND OF THE INVENTION

### Field of the Invention

The disclosure relates to a backlight module and a liquid-crystal display device using the same, and in particular to a backlight module and a liquid-crystal display device using the same, which reduce circuit area to lower the cost and provide brightness that is not influenced by variations of the environment or individual products.

### Description of the Related Art

The present backlight modules in use widely employ light-emitting diodes (LED) as the light source for liquid-crystal display (LCD) devices. According to the physical characteristic of LEDs, the brightness of an LED depends on the amount of electric current flowing through the LED. Therefore, a balance circuit is utilized to control the electric current flowing through each LED string to ensure the uniformity of brightness of the LED backlight.

FIG. 1 is a diagram showing that a balance circuit is used to control electric current flowing through each LED string in the backlight module according to conventional art. The backlight module has a plurality of LED strings S1 and S2, each of which is formed from a plurality of LEDs connected in series. Each LED string receives a DC voltage VLED supplied from a DC-DC converter 10. In each LED string, a field-effect transistor and a resistor are connected in series between the cathode end of the LED string and the ground. A microcontroller 20 detects the voltage across the resistor in each LED string to determine the current flowing through the string, and adjusts the equivalent impedance of the field-effect transistor to make the current flowing through each string the same. Here, a plurality of field-effect transistors forms a balance circuit 30. The conventional art uses a control circuit in a control chip that is a microcontroller 20 to control the balance circuit 30 outside the control chip. However, as the panel size gets bigger, the number of LEDs and the number of LED strings utilized in the backlight module continuously increase. Therefore, a balance circuit with a large area is needed to control the current of each string. This exacerbates the problems of high circuit cost and large circuit size.

In addition, even though each LED string achieves the same brightness, the current flowing through the LED string still changes in response to changes of the ambient temperature, causing variations in the brightness of the backlight module due to the outside environment. Furthermore, there is variation among the products of different backlight modules, which causes different maximum brightness levels among these backlight modules.

In view of the above problems, the disclosure provides a backlight module and a liquid-crystal display device using the same, which reduce circuit area for the balance circuit to lower the cost and provide a level of brightness that is not influenced by variations of the environment or products.

### BRIEF SUMMARY OF THE INVENTION

A detailed description is given in the following embodiments with reference to the accompanying drawings.

The disclosure provides a backlight module, including: a plurality of LED strings, each of which is formed from a plurality of LEDs connected in series and has an LED string current, and a dimming controller which controls the duty cycle of a voltage pulse wave supplied to each of the LED strings, wherein the LED string current of each of the LED strings multiplied by the duty cycle of the voltage pulse wave for the same LED string equals a value, and the value of each of the LED strings is substantially the same.

According to an embodiment, the dimming controller includes: a dimming block controlling the conduction period of each of the LED strings, and a command transmitting/receiving block controlling the dimming block according to duty cycle information required for each of the LED strings.

According to an embodiment, the command transmitting/receiving block receives the duty cycle information from a controller via wired or wireless communication.

According to an embodiment, the controller stores an algorism for calculating a characteristic parameter of each of the LED strings to obtain the duty cycle information.

According to an embodiment, the characteristic parameter of each of the LED strings is obtained by a photosensitive device detecting light illuminated from the backlight module.

According to an embodiment, the dimming controller includes: a dimming block controlling the conduction period of each of the LED strings, and a calculation block storing an algorism for calculating a characteristic parameter of each of the LED strings to obtain duty cycle information required for each of the LED strings, and controlling the dimming block according to the duty cycle information required for each of the LED strings.

According to an embodiment, the characteristic parameter of each of the LED strings is obtained by a photosensitive device detecting light illuminated from the backlight module.

The disclosure also provides a liquid-crystal display device, including a display panel, and a backlight module illuminating the display panel. The backlight module includes a plurality of LED strings and a dimming controller. Each of the LED strings is formed from a plurality of LEDs connected in series and has an LED string current. The dimming controller controls the duty cycle of a voltage pulse wave supplied to each of the LED strings. The LED string current of each of the LED strings multiplied by the duty cycle of the voltage pulse wave for the same LED string equals a value, and the value of each of the LED strings is substantially the same.

The disclosure also provides a backlight module, including a plurality of LED strings, a dimming controller, and a DC-DC converter having a DC voltage output terminal. Each of the LED strings is formed from a plurality of LEDs connected in series. The dimming controller adjusts the brightness of each of the LED strings. The plurality of LED strings includes a first LED string and a plurality of second LED strings. The first LED string has one end connected to the DC voltage output terminal and the other end grounded through the dimming controller and a sense resistor. Each of the second LED strings has one end connected to the DC voltage output terminal and the other end grounded through the dimming controller.

According to an embodiment, the dimming controller includes a comparison block and a command transmitting/receiving block. The comparison block compares the voltage across the sense resistor to a reference voltage, and outputs a comparison result. The command transmitting/receiving block receives the comparison result and outputs a voltage adjusting command to adjust the DC voltage output from the DC-DC converter, to make the voltage across the sense resistor equal to the reference voltage.

According to an embodiment, the resistance of the sense resistor and the value of the reference voltage are commonly applied to products provided with the same backlight module.

According to an embodiment, the dimming controller further includes a dimming block, used for controlling the conduction period of each of the LED strings to adjust the brightness of each of the LED strings.

According to an embodiment, when the backlight module performs a local dimming technique, the reference voltage is raised to make the DC-DC converter output a higher DC voltage, and the dimming block re-adjusts the conduction period of each of the LED strings to match the brightness required for different display areas.

According to an embodiment, the plurality of LED strings and the dimming controller are formed on the same substrate.

The disclosure also provides a liquid-crystal display device, including: a backlight module and a panel controller, wherein the backlight module includes: a plurality of LED strings, each of which is formed from a plurality of LEDs connected in series; a DC-DC converter having a DC voltage output terminal; and a dimming controller adjusting the brightness of each of the LED strings, wherein the plurality of LED strings includes: a first LED string having one end connected to the DC voltage output terminal and the other end grounded through the dimming controller and a sense resistor; and a plurality of second LED strings, each of which has one end connected to the DC voltage output terminal and the other end grounded through the dimming controller. The panel controller sends dimming control information to the dimming controller, and the dimming controller controls the conduction period of each of the LED strings according to the dimming control information.

According to an embodiment, the dimming controller includes a comparison block and a command transmitting/receiving block. The comparison block compares a voltage across the sense resistor and a reference voltage and outputting a comparison result. The command transmitting/receiving block receives the comparison result and outputs a voltage adjusting command to adjust the DC voltage output from the DC-DC converter to make the voltage across the sense resistor equal to the reference voltage.

According to an embodiment, the panel controller stores an algorism for calculating a characteristic parameter of each of the LED strings to obtain the dimming control information.

According to an embodiment, the characteristic parameter of each of the LED strings is obtained by a photosensitive device detecting light illuminated from the backlight module.

According to the above embodiments, the backlight module or the liquid-crystal display device of the disclosure can reduce circuit area for the balance circuit to lower the cost and provide brightness not influenced by variations of the environment or products.

### BRIEF DESCRIPTION OF THE DRAWINGS

The disclosure can be more fully understood by reading the subsequent detailed description and examples with references made to the accompanying drawings, wherein:

FIG. 1 is a diagram showing that a balance circuit is used to control electric current flowing through each LED string in the backlight module according to the prior art;

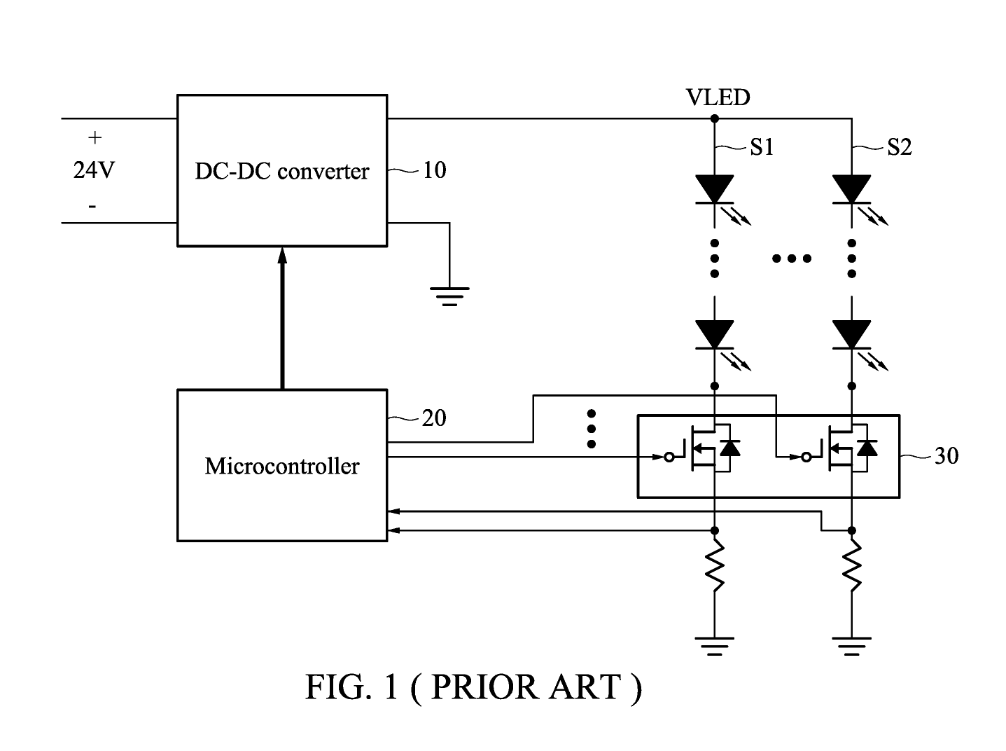

FIG. 2 is a diagram showing the steps for adjusting the brightness of the backlight module according to the disclosure;

FIG. 3 is a diagram showing that a dimming controller is used to control the average current flowing through each LED string in the backlight module according to an embodiment of the disclosure;

FIG. 4 is a diagram showing that a dimming controller is used to control the average current flowing through each LED string in the backlight module according to another embodiment of the disclosure;

FIG. 5A shows an example illustrating values of current flowing through each LED string;

FIG. 5B shows an example illustrating a voltage pulse wave supplied to each LED string;

FIG. 5C shows the average current of each LED string which is the product of the value of current shown in FIG. 5A and the duty shown in FIG. 5B;

FIG. 6 is a diagram showing that a dimming controller is used to control the average current flowing through each LED string in the backlight module according to another embodiment of the disclosure; and

FIG. 7 is a top view of a substrate where the backlight module shown in FIG. 6 is disposed.

### DETAILED DESCRIPTION OF THE INVENTION

The following description is of the contemplated mode of carrying out the disclosure. This description is made for the purpose of illustrating the general principles of the disclosure and should not be taken in a limiting sense. The scope of the disclosure is determined by reference to the appended claims.

The disclosure removes the balance circuit utilized in the prior art and adjusts the duty cycle of the voltage pulse wave supplied to each LED string by using a dimming controller to achieve a uniformity of brightness of the backlight module. Because the dimming controller is designed in a chip, the circuit area required for housing a balance circuit is unnecessary, and the manufacturing cost is reduced.

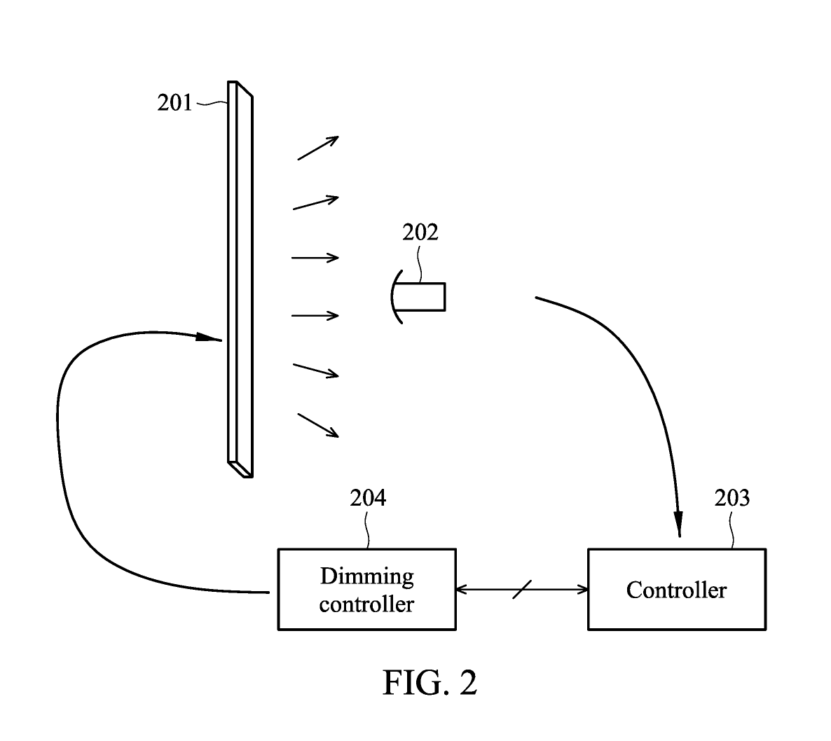

FIG. 2 is a diagram showing the steps for adjusting the brightness of the backlight module according to the disclosure. First, turn on a backlight module 201 provided with a plurality of LED strings to illuminate light, and measure the brightness of each LED string in the backlight module 201 using a photosensitive device 202 having photosensitive elements, such as CCDs. The photosensitive device 202 sends or stores the measurement result to a controller 203. The controller 203 can be a panel controller of an LCD device provided with the backlight module. The controller 203 has stored characteristic information regarding an LED (the relationship between brightness and current, the relationship between current and a duty cycle required, etc.) in advance. The controller 203 calculates a duty cycle of a voltage pulse wave appropriate for each LED string based on the measurement result and the characteristic information. The dimming controller 204 adjusts the duty cycle of the voltage pulse wave supplied to each LED string according to the duty cycle calculated out by the controller 203, so that the average current of each LED string is the same. A uniformity of brightness of the backlight module is achieved.

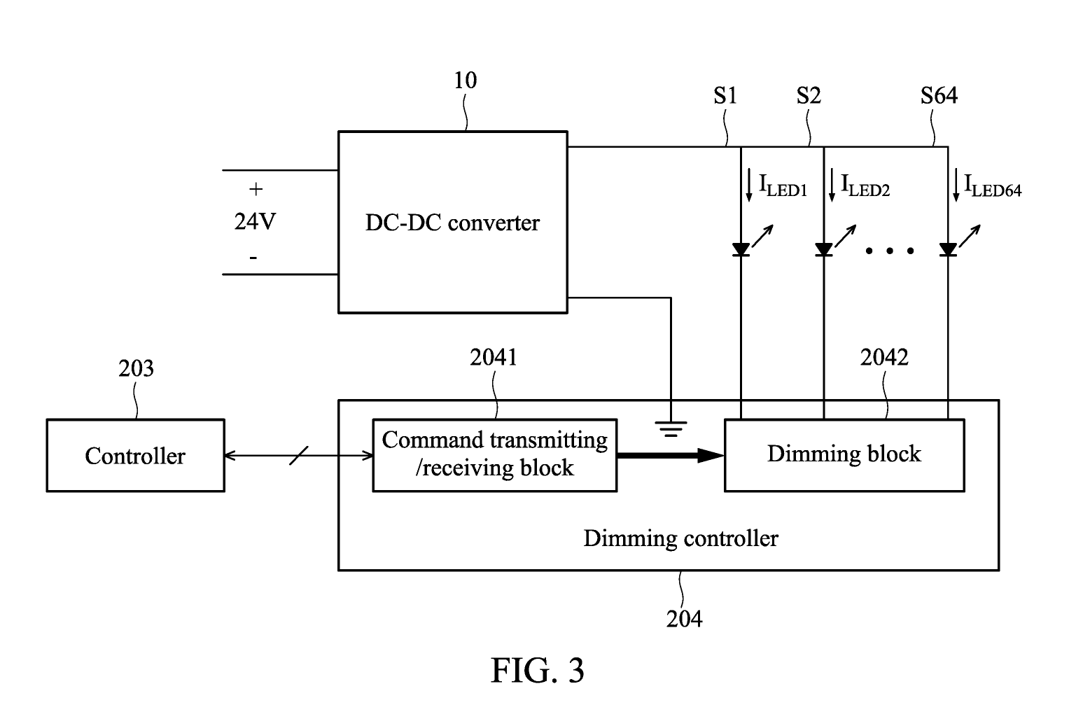

FIG. 3 is a diagram showing that a dimming controller is used to control the average current flowing through each LED string in the backlight module according to an embodiment of the disclosure. In FIG. 3, there are 64 LED strings. The strings S1, S2, and S64 are depicted as an example. As shown in FIG. 3, the dimming controller 204 has a command transmitting/receiving block 2041 and a dimming block 2042. The command transmitting/receiving block 2041 is used for receiving duty cycle information (equal to the dimming control information described in claims) output from the controller 203. The controller 203 can transmit the duty cycle information to the command transmitting/receiving block 2041 through various kinds of wire or wireless communication protocols. The command transmitting/receiving block 2041 controls the dimming block 2042 to adjust the conduction period of each LED string according to the duty cycle information. Thereby, the current values I_{LED 1}, I_{LED2}, and I_{LED64} of the LED strings S1, S2, and S64 are different, but the product of the current value of each LED string and the duty cycle of the voltage pulse wave for that LED string is the same. Namely, the average current for each LED string is substantially the same. Here, “substantially the same” means the error of the average current is within ±6%. This is a reasonable error range for the error generated by algorism, hardware, measurement, etc.

It can be seen in FIG. 3 that the disclosure removes the balance circuit in the conventional art. The dimming block 2042 is the circuit in the dimming controller (chip), so complicated extra circuits are not required. The brightness of the backlight module can be adjusted to be uniform by only the dimming circuit in the IC chip. The circuit area is substantially reduced and the manufacturing cost decreases. Furthermore, on the LED sting, the voltage across the balance circuit is also removed, so unnecessary power consumption is reduced, the heat generated by the LED string is lowered, and the illumination efficiency is increased.

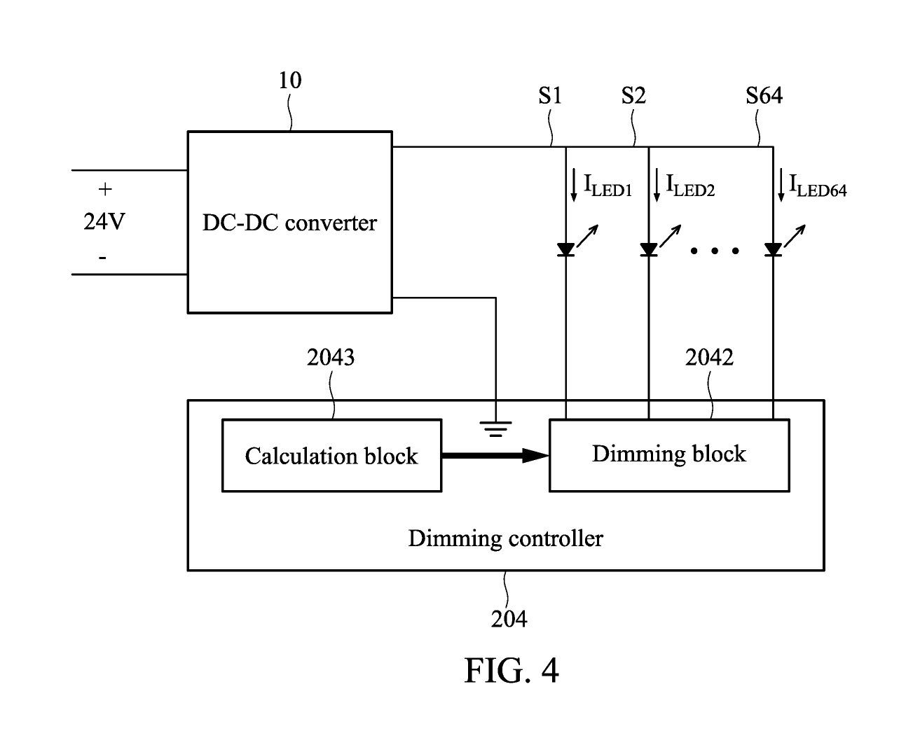

According to another embodiment of the disclosure, the calculation function of the controller 203 can be incorporated into the dimming controller 204. FIG. 4 is a diagram showing that a dimming controller is used to control the average current flowing through each LED string in the backlight module according to another embodiment of the disclosure. In FIG. 4, a calculation block 2043 performs the function of the controller 203 shown in FIG. 3. Namely, the calculation block 2043 has stored characteristic information regarding an LED (the relationship between brightness and current, the relationship between current and a duty cycle required, etc.) in advance, and calculates a duty cycle of a voltage pulse wave appropriate for each LED string based on the measurement result of the photosensitive device and the characteristic information. Then calculation block 2043 controls the dimming block 2042 to adjust the conduction period of each LED string according to the duty cycle information.

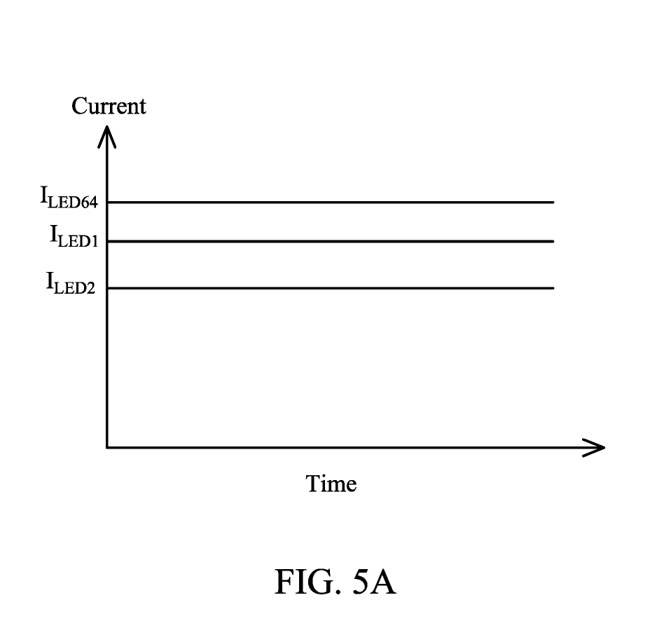

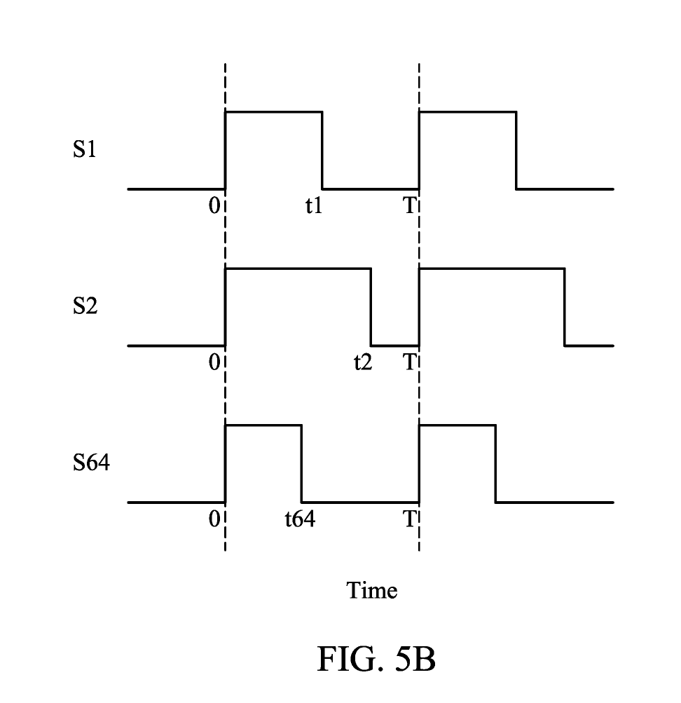

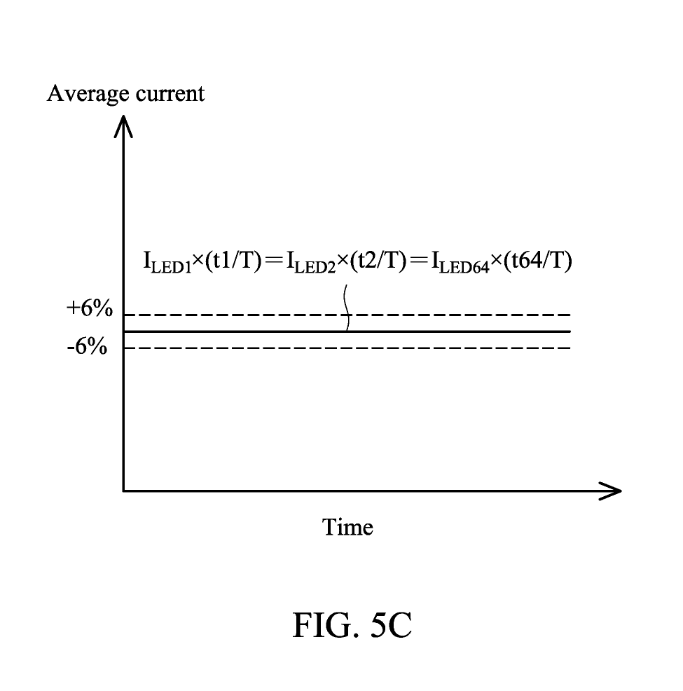

In the following paragraphs, the relationship between the current, the duty cycle, and the average current of each LED string is described. FIG. 5A shows an example illustrating the value of the current flowing through each LED string. As shown in FIG. 5A, the current flowing through the LED strings S1, S2, and S64 have different respective values I_{LED1}, I_{LED2}, and I_{LDE64}. The dimming controller supplies voltage pulse waves shown in FIG. 5B according to the current of each LED string. As shown in FIG. 5B, the width of a pulse of the voltage pulse wave for the LED string S1, S2, and S64 is t1, t2, and t64, respectively. Therefore, the duty cycle for the LED string S1, S2, and S64 is t1/T, t2/T, and t64/T, respectively. The greater the current value of a LED string, the less the duty cycle supplied to that LED string. Therefore, the average current is obtained as shown in FIG. 5C. the current values I_{LED1}, I_{LED2}, and I_{LDE64} of the LED strings S1, S2, and S64 is multiplied by the duty cycle t1/T, t2/T, and t64/T, respectively, and the same average current (I_{LED1}×(t1/T)=I_{LED2}×(t2/T)=I_{LED64}×(t64/T)) is obtained.

The embodiment doesn't change the current value of each LED string, but supplies a different duty cycle of the voltage pulse wave, so that the product of the current value of each LED sting and the duty cycle of the voltage pulse wave for that LED string is substantially the same. Namely, the average current of each LED string is substantially the same. Because each LED string has the same average current, the average brightness of each LED string is also the same. A uniformity of brightness of the backlight module is still achieved.

Next, the difference between the disclosure and the conventional local dimming technique is described. The local dimming technique can also control the duty cycle to adjust the brightness of different areas of the backlight. Thereby, the power consumption is greatly reduced, the contrast ratio of the display device is improved, the number of gray levels is increased, and motion blur is reduced. However, the local dimming technique is applied in the backlight module provided with the balance circuit. The balance circuit makes each LED string have the same current to generate uniform brightness. When the local dimming technique is utilized, the duty cycle of the voltage pulse wave for each LED string is adjusted to make a different average current for each LED string. Therefore, the brightness in different areas can be different. In this regard, the purpose of the conventional local dimming technique is to make the brightness in different areas of the backlight module different, but the purpose of the disclosure is to make the brightness in all areas of the backlight module the same. Their purposes are totally contrary to each other. Furthermore, the conventional local dimming technique is utilized in the backlight module provided with the balance circuit, which is also different from the disclosure which is utilized in a backlight module without a balance circuit.

The backlight module is mainly used as a backlight source in a liquid-crystal display device with a liquid-crystal display panel. According to the backlight module and the liquid-crystal display device using the same, the circuit area required in the backlight module is substantially reduced and the manufacturing cost decreases. Furthermore, the power that would otherwise be consumed by the balance circuit is saved, the heat generated by the LED string is lowered, and the illumination efficiency is increased.

However, even though the dimming controller adjusts the average current of each LED string to make the brightness of the entire backlight module uniform, the LED string current may change when the backlight module is placed in different environmental temperatures. This causes the backlight module to have a different brightness in different environmental temperatures. In addition, each backlight module has an individual variation causing the maximum brightness to be different from that of other backlight modules. The specifications of products are inconsistent.

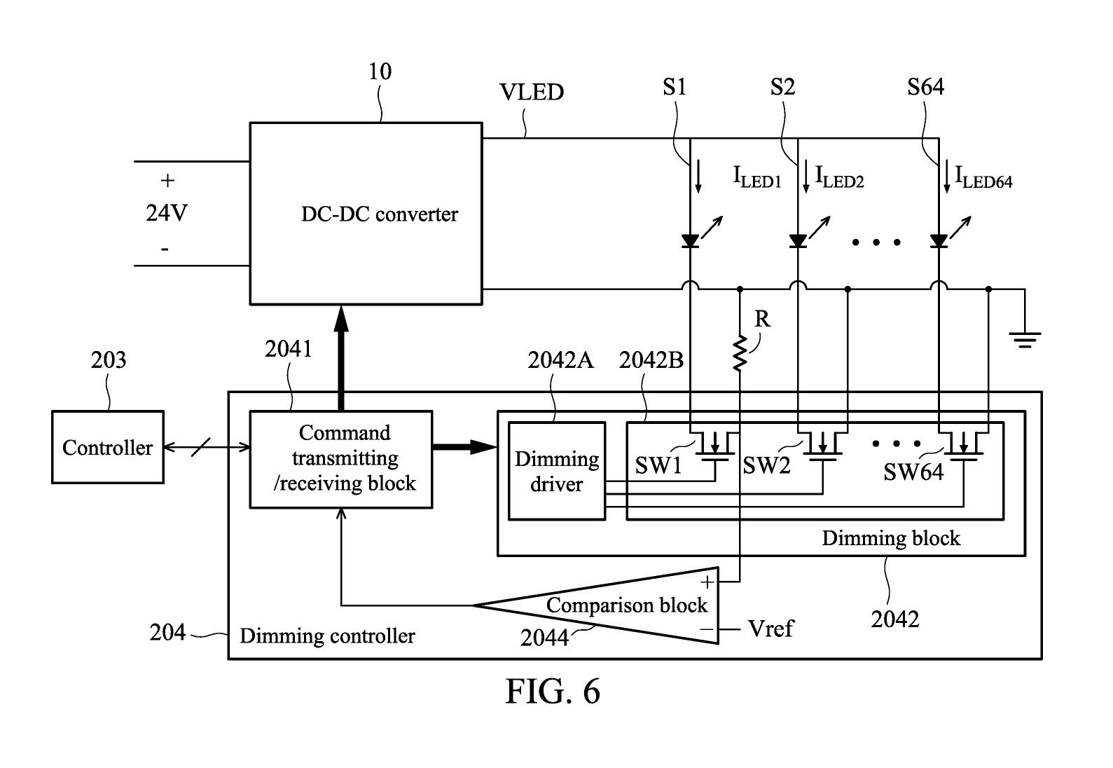

The disclosure further provides the following structure. FIG. 6 is a diagram showing that a dimming controller is used to control the average current flowing through each LED string in the backlight module according to another embodiment of the disclosure. In comparison with the configuration shown in FIG. 3, the dimming controller 204 further comprises a comparison block 2044 in addition to the command transmitting/receiving block 2041 and the dimming block 2042. A sense resistor R is connected between the LED string Si and the ground.

Specifically, the dimming block 2042 comprises a dimming driver 2042A and a switching portion 2042B. The switching portion 2042B comprises 64 switches SW1, SW2, . . . , and SW64 respectively connected between the cathode end of each LED string and the ground. The control terminal of each switch SW1, SW2, . . . , or SW64 is controlled by the diming controller 2042A, and thereby the conduction period of each switch SW1, SW2, . . . , or SW64 can be adjusted. In this embodiment, a sense resistor R is further connected between the switch SW1 and the ground. The voltage of the node between the switch SW1 and the sense resistor R (equal to the voltage across the sense resistor R) is input to the comparison block 2044. Thereby, the current value I_{LED1} of the LED string S1 can be detected.

The other input terminal of the comparison block 2044 is input with the reference voltage Vref, so the reference voltage Vref and the voltage across the sense resistor R are compared. The reference voltage Vref divided by the resistance of the sense resistor R equals a standard current value set for the LED string S1. Namely, when the voltage across the sense resistor R is equal to the reference voltage Vref, the current value of the LED string S1 is the standard current value. At this time, the brightness generated by the LED string S1 can be regarded as standard brightness. When the voltage across the sense resistor R is not equal to the reference voltage Vref, the comparison block 2044 will output a comparison result indicating that the voltage should be adjusted to the command transmitting/receiving block 2041. The command transmitting/receiving block 2041 outputs a voltage adjusting command to the DC-DC converter 10 according to the comparison result, so that the DC-DC converter 10 continuously adjusts its output DC voltage until the voltage across the sense resistor R has become equal to the reference voltage Vref. In this way, even though the backlight module is placed in different environmental temperatures, as long as the current value I_{LED1} of the LED string S1 is changed, it is immediately adjusted back to the standard current value to generate the standard brightness. Therefore, the backlight module can maintain a constant brightness in different environmental temperatures. If this reference voltage Vref and resistance of the sense resistor R are applied to other backlight modules with the same structure (though individual variations do exist) as well, the current value I_{LED1} of the LED string S1 of each backlight module can be adjusted to the standard current value, and the brightness specification for each backlight module can be the same.

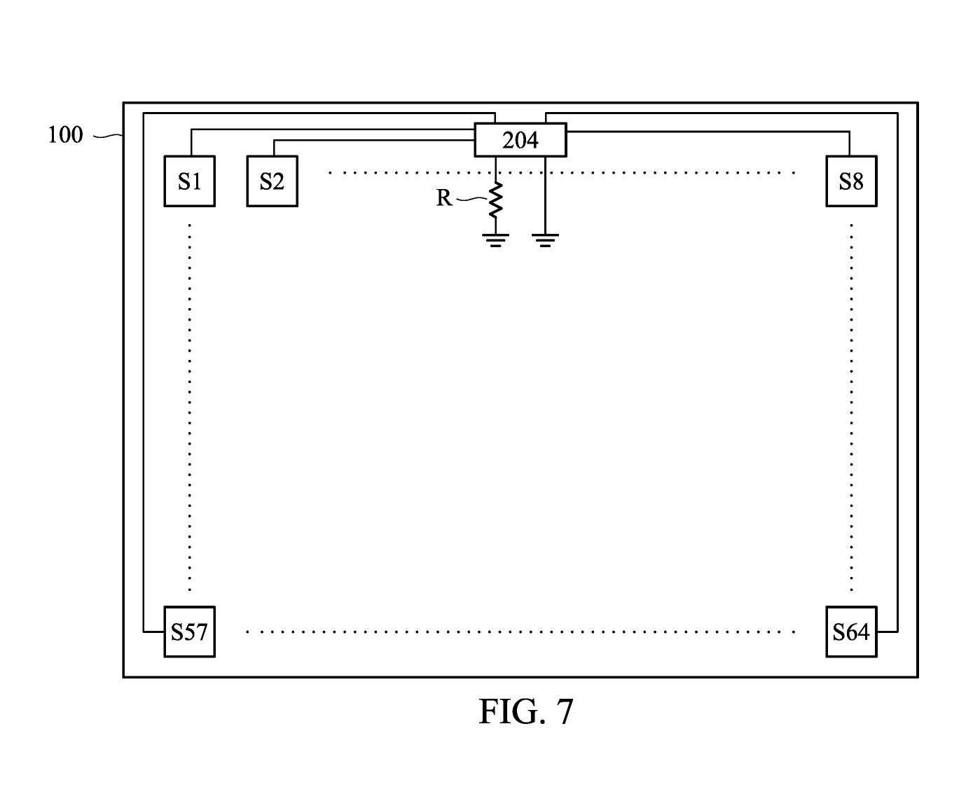

FIG. 7 is a top view of a substrate where the backlight module shown in FIG. 6 is disposed. As shown in FIG. 7, a direct-type backlight module is used as an example. Each LED string S1, S2, S8, S57, or S64 is disposed in a rectangular area. All rectangular areas are arranged on a backlight substrate 100 in a matrix formation. A feature of the disclosure is that the dimming controller 204 is also disposed on the backlight substrate 100. Each rectangular area is connected to the dimming controller 204 via a wire. The dimming controller 204 makes the rectangular area of the LED string S1 grounded through the sense resistor R, and makes the rectangular areas of the other the LED strings S2, S8, S57, and S64 grounded directly. It can be clearly understood from FIG. 7 that the circuit area is really reduced. By controlling the average current value of each LED string at the standard current value, the influence of environmental variation or individual variation can be eliminated.

The backlight module of the disclosure can be also applied for the local diming technique. For example, in the case that some display areas need high brightness and some display areas need low brightness to adjust the contrast of the displayed image, the backlight module of the disclosure can temporally raise the reference voltage Vref to increase the current values of all LED strings to achieve the maximum brightness of the displayed image. Then the controller 203 (panel controller) sends dimming control information for each LED string to the command transmitting/receiving block 2041 according to the brightness required for each display area. The command transmitting/receiving block 2041 outputs a conduction period adjusting command to the dimming block 2042. The dimming block 2042 controls the conduction period of each LED string to adjust the brightness of different display areas.

According to the backlight module and the liquid-crystal display device of the disclosure, the circuit area required in the backlight module is substantially reduced and the manufacturing cost decreases. Furthermore, the brightness of backlight module can be unaffected by the influence of environmental variations or individual variations.

While the disclosure has been described by way of example and in terms of the embodiments, it is to be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A backlight module, comprising
a plurality of LED strings, each of which is formed from a plurality of LEDs connected in series and has an LED string current, and
a dimming controller which controls a duty cycle of a voltage pulse wave supplied to each of the LED strings,
wherein the LED string current of each of the LED strings multiplied by the duty cycle of the voltage pulse wave for the same LED string equals a value, and the error between the values of the LED strings is within 6% of any of the values.

2. The backlight module as claimed in claim 1, wherein the dimming controller comprises:
a dimming block controlling a conduction period of each of the LED strings, and
a command transmitting/receiving block controlling the dimming block according to duty cycle information required for each of the LED strings.

3. The backlight module as claimed in claim 2, wherein the command transmitting/receiving block receives the duty cycle information from a controller via wired or wireless communication.

4. The backlight module as claimed in claim 3, wherein the controller stores an algorism for calculating a characteristic parameter of each of the LED strings to obtain the duty cycle information.

5. The backlight module as claimed in claim 4, wherein the characteristic parameter of each of the LED strings is obtained by a photosensitive device detecting light illuminated from the backlight module.

6. The backlight module as claimed in claim 1, wherein the dimming controller comprises:
a dimming block controlling a conduction period of each of the LED strings, and
a calculation block storing an algorism for calculating a characteristic parameter of each of the LED strings to obtain duty cycle information required for each of the LED strings, and controlling the dimming block according to the duty cycle information required for each of the LED strings.

7. The backlight module as claimed in claim 6, wherein the characteristic parameter of each of the LED strings is obtained by a photosensitive device detecting light illuminated from the backlight module.

8. A liquid-crystal display device, comprising:
a display panel; and
a backlight module emitting light to the display panel,
wherein the backlight module comprises:
a plurality of LED strings, each of which is formed from a plurality of LEDs connected in series and has an LED string current, and
a dimming controller which controls a duty cycle of a voltage pulse wave supplied to each of the LED strings,
wherein the LED string current of each of the LED strings multiplied by the duty cycle of the voltage pulse wave for the same LED string equals a value, and the error between the values of the LED strings is within 6% of any of the values.

9. A backlight module, comprising:
a plurality of LED strings, each of which is formed from a plurality of LEDs connected in series;
a DC-DC converter having a DC voltage output terminal; and
a dimming controller adjusting brightness of each of the LED strings,
wherein the plurality of LED strings comprises:
a first LED string having one end connected to the DC voltage output terminal and the other end grounded through the dimming controller and a sense resistor; and
a plurality of second LED strings, each of which has one end connected to the DC voltage output terminal and the other end grounded through the dimming controller.

10. The backlight module as claimed in claim 9, wherein the dimming controller comprises:
a comparison block comparing a voltage across the sense resistor and a reference voltage and outputting a comparison result, and
a command transmitting/receiving block receiving the comparison result and outputting a voltage adjusting command to adjust the DC voltage output from the DC-DC converter to make the voltage across the sense resistor equal to the reference voltage.

11. The backlight module as claimed in claim 10, wherein the resistance of the sense resistor and the value of the reference voltage are commonly applied to products provided with the backlight module.

12. The backlight module as claimed in claim 11, wherein the dimming controller further comprises:
a dimming block controlling a conduction period of each of the LED strings to adjust brightness of each of the LED strings.

13. The backlight module as claimed in claim 12, wherein when the backlight module performs a local dimming technique, the reference voltage is raised to make the DC-DC converter output higher DC voltage, and the dimming block re-adjusts the conduction period of each of the LED strings to match the brightness required for different display areas.

14. The backlight module as claimed in claim 9, wherein the plurality of LED strings and the dimming controller are formed on the same substrate.

15. A liquid-crystal display device, comprising:
a backlight module and a panel controller,
wherein the backlight module comprises:
a plurality of LED strings, each of which is formed from a plurality of LEDs connected in series;
a DC-DC converter having a DC voltage output terminal;
and a dimming controller adjusting brightness of each of the LED strings,
wherein the plurality of LED strings comprises:
a first LED string having one end connected to the DC voltage output terminal and the other end grounded through the dimming controller and a sense resistor; and
a plurality of second LED strings, each of which has one end connected to the DC voltage output terminal and the other end grounded through the dimming controller, and
wherein the panel controller sends dimming control information to the dimming controller, and the dimming controller controls a conduction period of each of the LED strings according to the dimming control information.

16. The liquid-crystal device as claimed in claim 15, wherein the dimming controller comprises:
a comparison block comparing a voltage across the sense resistor and a reference voltage and outputting a comparison result, and
a command transmitting/receiving block receiving the comparison result and outputting a voltage adjusting command to adjust the DC voltage output from the DC-DC converter to make the voltage across the sense resistor equal to the reference voltage.

17. The liquid-crystal device as claimed in claim 15, wherein the panel controller stores an algorism for calculating a characteristic parameter of each of the LED strings to obtain the dimming control information.

18. The liquid-crystal device as claimed in claim 15, wherein the characteristic parameter of each of the LED strings is obtained by a photosensitive device detecting light illuminated from the backlight module.
